(19) United States
(12) Patent Application Publication
(10) Pub. No.: US 2023/0169706 A1
(43) Pub. Date: Jun. 1, 2023

(54) DIAGRAM MODIFICATION DEVICE, DIAGRAM MODIFICATION METHOD, AND DIAGRAM MODIFICATION PROGRAM

(71) Applicant: NEC Corporation, Minato-ku, Tokyo (JP)

(72) Inventors: Dai KUBOTA, Tokyo (JP); Riki Eto, Tokyo (JP)

(73) Assignee: NEC Corporation, Minato-ku, Tokyo (JP)

(21) Appl. No.: 17/920,430

(22) PCT Filed: Apr. 28, 2020
(86) PCT No.: PCT/JP2020/018170

§ 371 Date: Oct. 21, 2022

(51) Int. Cl. G06T 11/20; B61L 27/16

(52) U.S. Cl. CPC G06T 11/206; B61L 27/16

(57) ABSTRACT

The output means 81 outputs a diagram to a display device. The input means 82 accepts designation of a change point and a change condition for the displayed diagram. The constraint generation means 83 generates a constraint for an objective function used for optimization of the diagram based on the designation. The change proposal generation means 84 generates a change proposal for the diagram by optimizing the objective function based on the generated constraint. Then, the input means 82 accepts, for each change point, the designation of a hard constraint indicating a condition that must be satisfied, or a soft constraint indicating a condition that increases a penalty according to degree of unsatisfactory, as the designation of the change condition, the constraint generation means 83 generates the constraint according to the hard constraint or soft constraint, and the output means 81 outputs the change proposal of the diagram.

### TECHNICAL FIELD

This invention relates to a diagram modification device, a diagram modification method, and a diagram modification program for modifying diagrams.

### BACKGROUND ART

Due to the development of mobility technologies, population growth and urban overcrowding, the number of transportation infrastructures such as railroads, airlines, buses, and ships, as well as their users, are in a state of continuous growth. Currently, most of the work related to transportation operation diagrams (operation schedules, or diagrams) is performed manually, and this work is becoming increasingly complex. Therefore, the use of AI (Artificial Intelligence) is expected from the viewpoint of labor saving and automation.

For example, Patent literature 1 describes an operation management support device that performs operation management related to reducing train delays and the like. The device described in Patent literature 1 identifies configurations to be modified in order to operate trains according to the modified schedule data, based on the difference between the actual schedule data and the fixed schedule data, and configuration information.

### Citation List

### Patent Literature

PTL 1: Japanese Patent Laid-Open No. 2019-93906

### SUMMARY OF INVENTION

### Technical Problem

In the fields of railroads and aviation, information indicating current conditions, such as problems that have occurred, is overwhelmingly in the form of information that is reported to the central command center after it has been confirmed by on-site workers, making it difficult to extract skilled-level information from sensor and monitoring data alone. Therefore, since full automation by AI alone is currently difficult, even when AI is used, it is required to respond to changes in the fixed time schedule in an interactive manner with human operators.

When a trouble occurs that necessitates a change in the fixed time schedule, instructions for plan modification are usually required as soon as possible. In this case, it is desirable to minimize the time required for operation instructions in addition to the time required for the plan revision itself. The same applies to the use of AI, where the time required for input of modification details and operation instructions to the AI must also be minimized.

However, when Al is used to optimize an operation schedule that is to be modified, the constraint conditions required for the modification usually need to be given directly in a mathematical formula. Therefore, even if a modification policy is decided, the work of converting complex constraint conditions into mathematical formulas and inputting them into a computer is time-consuming.

For example, by using the device described in Patent literature 1, it is possible to identify the configuration to be modified and the indicators to solve the problem. However, the device described in Patent literature 1 does not consider the method of subsequent plan modification or operation instructions, so even if problems can be identified, there is a problem that the subsequent processing takes time.

Therefore, in order to save labor and speed up planning work through interactive AI, i.e., in order to realize appropriate and quick changes to the operation schedule, it is desirable that the humans performing the work be able to intuitively provide the instructions necessary for optimization.

Therefore, it is an exemplary object of the present invention is to provide a diagram modification device, a diagram modification method, and a diagram modification program that can provide optimization instructions for a modified diagram in a manner that can be intuitively recognized by humans.

### Solution to Problem

The diagram modification device according to the present invention including: an output means which outputs a diagram to a display device; an input means which accepts designation of a change point and a change condition for the displayed diagram; a constraint generation means which generates a constraint for an objective function used for optimization of the diagram based on the designation; and a change proposal generation means which generates a change proposal for the diagram by optimizing the objective function based on the generated constraint, wherein the input means accepts, for each change point, the designation of a hard constraint indicating a condition that must be satisfied, or a soft constraint indicating a condition that increases a penalty according to degree of unsatisfactory, as the designation of the change condition, the constraint generation means generates the constraint according to the hard constraint or soft constraint, and the output means outputs the change proposal of the diagram.

The diagram modification method according to the present invention including: outputting a diagram to a display device; accepting designation of a change point and a change condition for the displayed diagram; when accepting the designation, for each change point, accepting the designation of a hard constraint indicating a condition that must be satisfied, or a soft constraint indicating a condition that increases a penalty according to degree of unsatisfactory, as the designation of the change condition; generating a constraint for an objective function used for optimization of the diagram according to the hard constraint or the soft constraint, based on the designation; generating a change proposal for the diagram by optimizing the objective function based on the generated constraint; and outputting the change proposal of the diagram.

The diagram modification program according to the present invention causing the computer to execute: an output process of outputting a diagram to a display device; an input process of accepting designation of a change point and a change condition for the displayed diagram; a constraint generation process of generating a constraint for an objective function used for optimization of the diagram based on the designation; and a change proposal generation process of generating a change proposal for the diagram by optimizing the objective function based on the generated constraint, wherein, the designation of a hard constraint indicating a condition that must be satisfied, or a soft constraint indicating a condition that increases a penalty according to degree of unsatisfactory, as the designation of the change condition is accepted for each change point, in the input process, the constraint is generated according to the hard constraint or soft constraint, in the constraint generation process, and the change proposal of the diagram is output, in the output process.

### Advantageous Effects of Invention

According to the present invention, optimization instructions for a modified diagram can be provided in a manner that can be intuitively recognized by humans.

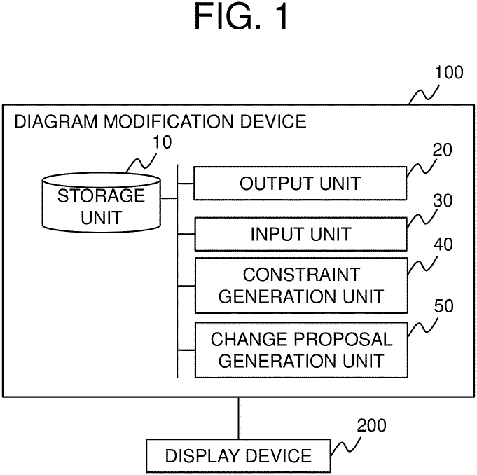

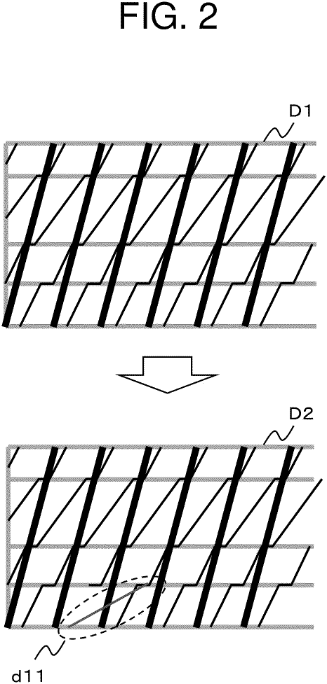

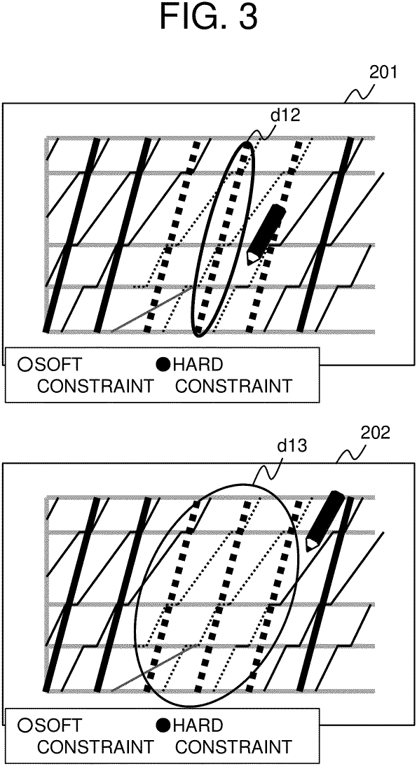

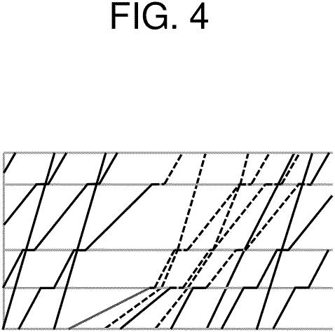

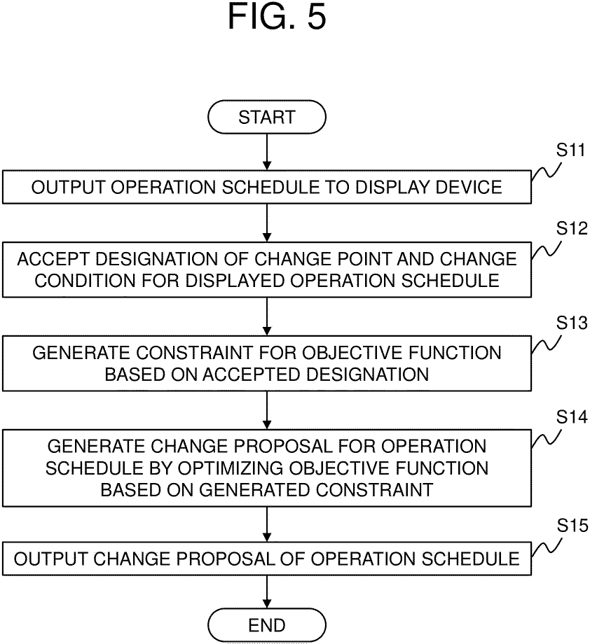

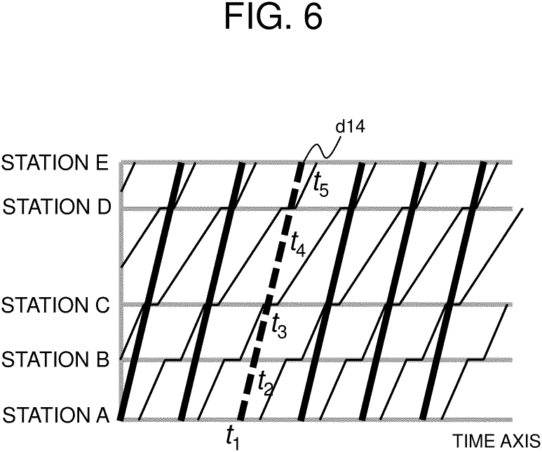

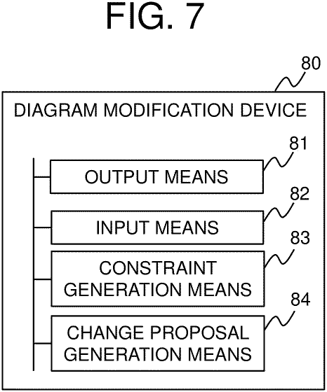

### BRIEF DESCRIPTION OF DRAWINGS

[FIG. 1] It depicts a block diagram showing a configuration example of an exemplary embodiment of an operational schedule change device according to the present invention.

[FIG. 2] It depicts an explanatory diagram showing an example of an operation schedule.

[FIG. 3] It depicts an explanatory diagram showing an example of a designation that is accepted.

[FIG. 4] It depicts an explanatory diagram showing an example of an output of a change proposal of the operation schedule.

[FIG. 5] It depicts a flowchart showing an operation example of the diagram modification device.

[FIG. 6] It depicts an explanatory diagram showing an example of a case in which the railroad schedule is changed.

[FIG. 7] It depicts a block diagram showing an overview of a diagram modification device according to the present invention.

### DESCRIPTION OF EMBODIMENTS

The following is a description of the exemplary embodiment of the invention with reference to the drawings.

FIG. 1 is a block diagram showing a configuration example of an exemplary embodiment of a diagram modification device according to the present invention. The diagram modification device 100 of this exemplary embodiment includes a storage unit 10, an output unit 20, an input unit 30, a constraint generation unit 40, and a change proposal generation unit 50. The diagram modification device 100 is connected to a display device 200.

The diagram modification device 100 in this exemplary embodiment accepts instructions from the user for the contents of the display. Therefore, it is preferable that the display device 200 used in this exemplary embodiment has a function to display as well as a function to directly accept input from the user. Such a display device 200 may be a pen tablet or a touch panel.

However, the display device 200 itself may not be able to accept direct input. For example, the cursor operation of a user using a pointing device may be displayed on the display device 200 to accept various instructions from the user.

The storage unit 10 stores parameters and various information used by the diagram modification device 100 for processing. Specifically, the storage unit 10 stores a predetermined operation schedule (hereinafter referred to as a fixed time schedule). The storage unit 10 also stores an objective function used in the operation schedule optimization process.

The form of the objective function used in this exemplary embodiment is arbitrary. The objective function may be, for example, an objective function generated by inverse reinforcement learning and inverse optimization, or an objective function as used in methods widely known in operations research (e.g., mixed integer programming problems). Furthermore, since the optimization of train schedules can be large-scale, the objective function may be represented by an Ising model, such as that handled by an annealing quantum computer.

The output unit 20 outputs the target diagram (operation schedule) to the display device 200. In addition, the output unit 20 of this exemplary embodiment outputs the difference from the fixed time schedule and the fixed time schedule caused by delays or failures. FIG. 2 is an explanatory diagram showing an example of an operation schedule displayed by the output unit 20. For example, it is assumed that the operation schedule D1 illustrated in FIG. 2 is a fixed time schedule. When the operation schedule is disrupted due to a delay or a fault, the output unit 20 the operation schedule D2 including the difference d11 from the fixed time schedule.

The range of the operation schedule output by the output unit 20 and the form of the difference are arbitrary. For example, the output unit 20 may output an operation schedule that includes the difference, or may output an operation schedule for a range specified by the user (e.g., a range of times and stations). The output unit 20 may also output the differences in a manner that is distinguishable from the fixed time schedule (e.g., changing color, highlighting, etc.).

The input unit 30 accepts designation of a change point and a change condition for the output operation schedule. The change point may be, for example, part or all of a specific service (train, aircraft, etc.) or a predetermined range of services. In addition, the change condition includes the specific details of the change (operation time, operation speed, etc.) as well as the strength of the constraint that must be satisfied when the change is made. The strength of constraint is broadly classified into two types: one is a constraint that must be satisfied, and the other is a constraint that increases some penalty according to degree of unsatisfactory. In the following explanation, the former type of constraint is referred to as a hard constraint, while the latter is referred to as a soft constraint.

Furthermore, when the soft constraint is specified, the input unit 30 may accept the designation of a function type that defines the degree of penalty to be generated (degree of softness). The input unit 30 may directly accept input of the function type, or may allow the user to select from a predefined list of function types according to the degree of softness. The specific details of function types are described below.

FIG. 3 is an explanatory diagram showing an example of a designation that is accepted by the input unit 30. In FIG. 3, the screen 201 shows an example of a hard constraint instruction d12 accepted by the user, and the screen 202 shows an example of a soft constraint instruction d13 accepted by the user. In the example shown in FIG. 3, for example, the instruction d12 represents the constraint that a specified range of services be operated on time, and the instruction d13 represents the constraint to optimize the specified range so that as few changes as possible are made.

In FIG. 3, the method of accepting the designation of a range of change points and accepting either the soft constraint or the hard constraint as a change condition for the specified range is shown as an example. However, the method in which the input unit 30 accepts the designation of a change point and a change condition is not limited to the method illustrated in FIG. 3. It is sufficient to predetermine the correspondence between the designation to the operation schedule and the contents of the change that the designation implies, so that the meaning of the change instruction made to the displayed operation schedule can be specified.

The designation of the hard constraint or the soft constraint is not limited to on-screen designation, but may also be specified, for example, by buttons on a pen tablet.

The specific operations for the change instruction include range input using a pen tablet or touch panel, and clicking on a cursor displayed on the screen using a pointing device or selecting a rectangle.

The constraint generation unit 40 generates a constraint for the objective function used for optimization of the operation schedule based on the designation of the change point and the change condition. In particular, the constraint generation unit 40 generates the constraints according to the hard constraint or the soft constraint described above. Specifically, the constraint generation unit 40 generates constraints where the hard constraint is an optimization condition and the soft constraint is component of the objective function.

The hard constraint and the soft constraint can be treated similarly to features that are components of the objective function in inverse reinforcement learning and inverse optimization, for example. In particular, in a wide range of optimization problems, such as mixed integer programming problems, one constraint equation can be treated as a linear equation denoted by the equality (a • x + b = 0) or inequality (a • x + b > 0). In the above linear equation, x is a variable to be optimized. In other words, generating the constraint equation is equivalent to generating the coefficient vector a and scalar value b.

As described above, since the hard constraint is a constraint that must be satisfied, the constraint generation unit 40 treats the hard constraint as an essential condition for optimizing the objective function (i.e., optimization conditions). The constraint generation unit 40 may generate a linear equation indicating the constraints according to the designation of the change point and the change condition as an optimization condition.

The soft constraint, as described above, is a constraint that generate some penalty depending on the degree to which the constraint is not satisfied. On the other hand, in the case of the soft constraint, unlike the hard constraint, it is necessary to negotiate a penalty in the objective function in case the constraint is not satisfied. The constraint generation unit 40 may express the penalty using a function f (a • x + b) that specifies the penalty (degree of softness) to be generated depending on the degree to which the constraint is not satisfied.

For example, if the soft constraint to be handled is represented by the inequality a • x + b > 0, the constraint generation unit 40 may use the function f illustrated in Equation 1 below as a constraint. [Math. 1]

$$f \left(a ⋅ x + b\right) = \left\{\begin{matrix}0 \left(a ⋅ x + b \leq 0\right) \\ 0 o r m o r e \left(a ⋅ x + b > 0\right)\end{matrix}\right)$$

A specific example of the type of function f in this case is the hinge function. Other types of functions may also be used for the non-negative part of the function f, such as polynomials for (a • x + b), an exponential function, a logarithmic function, and a composite function of these functions, as well as discontinuous functions such as Heaviside staircase functions. The type of function f may be predetermined or selected by the user via the input unit 30.

On the other hand, when the soft constraint to be handled is represented by the equality a • x + b = 0, the constraint generation unit 40 may use the function f illustrated in Equation 2 below as a constraint. [Math. 2]

$$f \left(a ⋅ x + b\right) = \left\{\begin{matrix}0 \left(a ⋅ x + b = 0\right) \\ 0 o r m o r e \left(a ⋅ x + b \neq 0\right)\end{matrix}\right)$$

A specific example of the type of function f in this case is the polynomial (a • x + b)² . In the case of equality, as in the case of inequality, various functions can be used.

Therefore, when generating the soft constraint (i.e., when the soft constraint is specified), the constraint generation unit 40 may determine whether the constraint is expressed in terms of equality or inequality based on the designation of the change point and the change condition. The constraint generation unit 40 may then identify a function based on the judgment result and the designation of the type of function f, and generate a constraint in which the identified function is a component of the objective function.

The change proposal generation unit 50 generates a change proposal for the operation schedule by optimizing the objective function based on the constraints generated by the constraint generation unit 40. Specifically, the change proposal generation unit 50 generates the change proposal for the operation schedule by optimizing the objective function including the soft constraint under the optimization condition generated by the constraint generation unit 40.

The form of the change proposal generation unit 50 is arbitrary as long as optimization is possible based on the objective function and conditions used in this exemplary embodiment. For example, the change proposal generation unit 50 may be realized by an optimization engine (optimization solver) that performs optimization processing based on the specified objective function and conditions (optimization conditions). When the objective function is represented by an Ising model, the change proposal generation unit 50 may, for example, cause a quantum computer that solves the optimization problem using quantum annealing to perform the optimization process. In other words, when the objective function is represented by an Ising model, the optimization process may be performed using a quantum computer while generating the change proposal for the operation schedule using a general computer.

When the proposed change is generated by the change proposal generation unit 50, the output unit 20 outputs the generated proposed change of the operation schedule. For example, the output unit 20 preferably causes the display device 200 to display changes from the fixed time schedule in a manner distinguishable from the fixed time schedule before the change. FIG. 4 is an explanatory diagram showing an example of an output of a change proposal to the operation schedule. In the example shown in FIG. 4, the change points are indicated by dotted lines.

Furthermore, the input unit 30 may accept the specification of the change point and the change condition for the change proposal to the operation schedule. In this case, the constraint generation unit 40 may generate the constraint for the objective function based on the designation, and the change proposal generation unit 50 may generate further change proposal for the change proposal to the operation schedule by optimizing the objective function based on the generated constraint. In this way, it is possible to create a change proposal that considers more desired changes to the change proposal.

At this time, the input unit 30 may accept not only the designation of the change point and change condition for the change proposal to the operation schedule, but also the designation of a fixed point that is not to be changed for the change proposal in the operation schedule. The designation of the fixed point corresponds to the hard constraint. By accepting such a specification, it is possible to create an operation schedule that the user intentionally does not allow to be changed, even when the change proposal is re-created.

The output unit 20, the input unit 30, the constraint generation unit 40, and the change proposal generation unit 50 are realized by a processor (for example, CPU (Central Processing Unit), GPU (Graphics Processing Unit)) of a computer that operates according to a program (a diagram modification program).

For example, a program may be stored in a storage unit 10, and the processor may read the program and operate as the output unit 20, the input unit 30, the constraint generation unit 40, and the change proposal generation unit 50 according to the program. In addition, the functions of the output unit 20, the input unit 30, the constraint generation unit 40, and the change proposal generation unit 50 may be provided in the form of SaaS (Software as a Service).

The output unit 20, the input unit 30, the constraint generation unit 40, and the change proposal generation unit 50 may each be realized by dedicated hardware. For example, when the objective function is represented by an Ising model, as described above, part of the change proposal generation unit 50 may be realized by a quantum computer. Some or all of the components of each device may be realized by general-purpose or dedicated circuit, a processor, or combinations thereof. These may be configured by a single chip or by multiple chips connected through a bus. Some or all of the components of each device may be realized by a combination of the above-mentioned circuit, etc., and a program.

When some or all of the components of the output unit 20, the input unit 30, the constraint generation unit 40, and the change proposal generation unit 50 are realized by multiple information processing devices, circuits, etc., the multiple information processing devices, circuits, etc. may be centrally located or distributed. For example, the information processing devices, circuits, etc. may be realized as a client-server system, a cloud computing system, etc., each of which is connected through a communication network.

Next, the operation example of this exemplary embodiment of the diagram modification device 100 will be described. FIG. 5 is a flowchart showing an operation example of the diagram modification device 100. The output unit 20 outputs a current operation schedule to the display device 200 (step S11). The input unit 30 accepts designation of a change point and a change condition for the displayed operation schedule (step S12). Specifically, the input unit 30 accepts the designation of the soft constraint or the hard constraint for each change point. The constraint generation unit 40 generates a constraint for the objective function based on the accepted designation (step S13). The change proposal generation unit 50 generates a change proposal for the operation schedule by optimizing the objective function based on the generated constraint (step S14). The output unit 20 then outputs the change proposal of the operation schedule (step S15).

Thereafter, as necessary, the input unit 30 accepts the designation of the change point and the change condition for the change proposal to the operation schedule, the constraint generation unit 40 generates the constraint for the objective function based on the designation, and the change proposal generation unit further change proposal for the operation schedule by optimizing the objective function based on the constraint.

As described above, in this exemplary embodiment, the output unit 20 outputs an operation schedule to the display device 200, and the input unit 30 accepts designation of a change point and a change condition for the displayed operation schedule. The constraint generation unit 40 generates a constraint for the objective function based on the accepted designation, and the change proposal generation unit 50 generates a change proposal for the operation schedule by optimizing the objective function based on the generated constraint. In this case, the input unit 30 accepts the designation of the hard constraint or the soft constraint for each change point as the designation of the change condition, the constraint generation unit 40 generates the constraint according to the hard constraint or the soft constraint, and the output unit 20 outputs the change proposal of the operation schedule. With such a configuration, optimization instructions for a modified diagram can be provided in a manner that can be intuitively recognizable by humans.

Next, specific examples of the diagram modification device 100 will be described. FIG. 6 is an explanatory diagram showing an example of a case in which the railroad schedule is changed. First, the output unit 20 outputs the railroad diagram illustrated in FIG. 6. Then, in this specific example, it is assumed that the input unit 30 accepts a change instruction for a certain railroad schedule line d14. The designated points accepted by the input unit 30 in FIG. 6 are indicated by dotted lines.

In the case of a railroad schedule, each schedule line is designated by a series of coordinates that indicate at what station (or location between stations) a train is at what time of day. In addition to the time and location information, the designation of each schedule line may also include the number sign of the line in use. In the example shown in FIG. 6, {(t₁, station A), (t₂, station B), (t₃, station C), (t₄, station D), (t₅, station E)} represent a single train schedule (e.g., an express train). For example, a train stopping at each station is represented by {..., t₁, station A), (t₂, station B), (t₃, station C), (t₄, station D), (t₅, station E), ...}.

For example, it is assumed that this change instruction is a hard designation. In this case, it corresponds to a constraint not to move the selected operation schedule. In other words, this change instruction is an equational constraint on the variable of what time the train should arrive at each station. The constraint generation unit 40 may, for example, generate constraints according to predefined rules, such as t = t₁ and the variable s = “Station A”. The constraint generation unit 40 can then input the generated constraints as optimization conditions to the change proposal generation unit 50, which is an optimization solver, independently of the objective function.

On the other hand, it is assumed that this change instruction is the soft constraint. In this case, the constraint corresponds to a constraint of not moving the selected operation schedule as much as possible. After generating the constraint (e.g., f(a • x+b)) as well as hard constraints, the constraint generation unit 40 generates the objective function with the generated constraints directly added, which is input to the change proposal generation unit 50.

The change proposal generation unit 50 generates a change proposal for the operation schedule by optimizing the objective function based on the input objective function and optimization conditions.

Next, an overview of the present invention will be described. FIG. 7 is a block diagram showing an overview of a diagram modification device according to the present invention. The diagram modification device 80 (e.g., diagram modification device 100) according to the present invention includes an output means 81 (e.g., output unit 20) which outputs a diagram (e.g., operation schedule) to a display device (e.g., display device 200), an input means 82 (e.g., input unit 30) which accepts designation of a change point and a change condition for the displayed diagram, a constraint generation means 83 (e.g., constraint generation unit 40) which generates a constraint for an objective function used for optimization of the diagram based on the designation, and a change proposal generation means 84 (e.g., change proposal generation unit 50) which generates a change proposal for the diagram by optimizing the objective function based on the generated constraint.

Then, the input means 82 accepts, for each change point, the designation of a hard constraint indicating a condition that must be satisfied, or a soft constraint indicating a condition that increases a penalty according to degree of unsatisfactory, as the designation of the change condition, the constraint generation means 83 generates the constraint according to the hard constraint or soft constraint, and the output means 81 outputs the change proposal of the diagram.

Such a configuration allows optimization instructions for the modified diagram to be provided in a manner that is intuitively recognizable by humans.

The constraint generation means 83 may generate the constraint in which the hard constraint is an optimization condition and the soft constraint is component of the objective function, and the change proposal generation means 84 may generate a change proposal for the diagram by optimizing the objective function including the soft constraint under the optimization condition.

The constraint generation means 83 may represent the soft constraint by a penalty function that specifies the penalty to be generated depending on degree to which the constraint is not satisfied.

The input means 82 may accept the designation of the change point and the change condition for the change proposal to the diagram operation schedule, the constraint generation means 83 may generate the constraint for the objective function based on the designation, and the change proposal generation means 84 may generate further change proposal for the diagram by optimizing the objective function based on the constraint.

The input means 82 may accept the designation of a fixed point that is not to be changed for the change proposal in the diagram, and the constraint generation means 83 may generate the constraint for the objective function based on the designation.

Although some or all of the above exemplary embodiments may also be described as in the following Supplementary notes, the present invention is not limited to the following.

(Supplementary note 1) A diagram modification device comprising: an output means which outputs a diagram to a display device; an input means which accepts designation of a change point and a change condition for the displayed diagram; a constraint generation means which generates a constraint for an objective function used for optimization of the diagram based on the designation; and a change proposal generation means which generates a change proposal for the diagram by optimizing the objective function based on the generated constraint, wherein the input means accepts, for each change point, the designation of a hard constraint indicating a condition that must be satisfied, or a soft constraint indicating a condition that increases a penalty according to degree of unsatisfactory, as the designation of the change condition, the constraint generation means generates the constraint according to the hard constraint or soft constraint, and the output means outputs the change proposal of the diagram.

(Supplementary note 2) The diagram modification device according to Supplementary note 1, wherein the constraint generation means generates the constraint in which the hard constraint is an optimization condition and the soft constraint is component of the objective function, and the change proposal generation means generates a change proposal for the diagram by optimizing the objective function including the soft constraint under the optimization condition.

(Supplementary note 3) The diagram modification device according to Supplementary note 1 or 2, wherein the constraint generation means represents the soft constraint by a penalty function that specifies the penalty to be generated depending on degree to which the constraint is not satisfied.

(Supplementary note 4) The diagram modification device according to any one of Supplementary notes 1 to 3, wherein the input means accepts the designation of the change point and the change condition for the change proposal to the diagram operation schedule; the constraint generation means generates the constraint for the objective function based on the designation, and the change proposal generation means generates further change proposal for the diagram by optimizing the objective function based on the constraint.

(Supplementary note 5) The diagram modification device according to Supplementary note 4, wherein the input means accepts the designation of a fixed point that is not to be changed for the change proposal in the diagram, and the constraint generation means generates the constraint for the objective function based on the designation.

(Supplementary note 6) A diagram modification method comprising: outputting a diagram to a display device; accepting designation of a change point and a change condition for the displayed diagram; when accepting the designation, for each change point, accepting the designation of a hard constraint indicating a condition that must be satisfied, or a soft constraint indicating a condition that increases a penalty according to degree of unsatisfactory, as the designation of the change condition; generating a constraint for an objective function used for optimization of the diagram according to the hard constraint or the soft constraint, based on the designation; generating a change proposal for the diagram by optimizing the objective function based on the generated constraint; and outputting the change proposal of the diagram.

(Supplementary note 7) The diagram modification method according to Supplementary note 6, wherein the constraint in which the hard constraint is an optimization condition and the soft constraint is component of the objective function is generated, and a change proposal for the diagram is generated by optimizing the objective function including the soft constraint under the optimization condition.

(Supplementary note 8) A program recording medium in which a diagram modification program is recorded, the diagram modification program causing a computer to execute: an output process of outputting a diagram to a display device; an input process of accepting designation of a change point and a change condition for the displayed diagram; a constraint generation process of generating a constraint for an objective function used for optimization of the diagram based on the designation; and a change proposal generation process of generating a change proposal for the diagram by optimizing the objective function based on the generated constraint, wherein, the designation of a hard constraint indicating a condition that must be satisfied, or a soft constraint indicating a condition that increases a penalty according to degree of unsatisfactory, as the designation of the change condition is accepted for each change point, in the input process, the constraint is generated according to the hard constraint or soft constraint, in the constraint generation process, and the change proposal of the diagram is output, in the output process.

(Supplementary note 9) The program recording medium in which the diagram modification program is recorded according to Supplementary note 8, the constraint in which the hard constraint is an optimization condition and the soft constraint is component of the objective function is generated, in the constraint generation process, and a change proposal for the diagram is generated by optimizing the objective function including the soft constraint under the optimization condition, in the change proposal generation process.

(Supplementary note 10) A diagram modification program causing a computer to execute: an output process of outputting a diagram to a display device; an input process of accepting designation of a change point and a change condition for the displayed diagram; a constraint generation process of generating a constraint for an objective function used for optimization of the diagram based on the designation; and a change proposal generation process of generating a change proposal for the diagram by optimizing the objective function based on the generated constraint, wherein, the designation of a hard constraint indicating a condition that must be satisfied, or a soft constraint indicating a condition that increases a penalty according to degree of unsatisfactory, as the designation of the change condition is accepted for each change point, in the input process, the constraint is generated according to the hard constraint or soft constraint, in the constraint generation process, and the change proposal of the diagram is output, in the output process.

(Supplementary note 11) The diagram modification program according to Supplementary note 10, the constraint in which the hard constraint is an optimization condition and the soft constraint is component of the objective function is generated, in the constraint generation process, and a change proposal for the diagram is generated by optimizing the objective function including the soft constraint under the optimization condition, in the change proposal generation process.

Although the present invention has been described with reference to the exemplary embodiments and examples, the present invention is not limited to the foregoing exemplary embodiments and examples. Various changes understandable by those skilled in the art can be made to the structures and details of the present invention within the scope of the present invention.

Reference Signs List

| | |
|---|---|
| 10 | Storage unit |
| 20 | Output unit |
| 30 | Input unit |
| 40 | Constraint generation unit |
| 50 | Change proposal generation unit |
| 100 | Diagram modification device |

What is claimed is:

1. A diagram modification device comprising:
a memory storing instructions; and
one or more processors configured to execute the instructions to:
output a diagram to a display device;
accept designation of a change point and a change condition for the displayed diagram;
generate a constraint for an objective function used for optimization of the diagram based on the designation; and
generate a change proposal for the diagram by optimizing the objective function based on the generated constraint,
wherein the processor is configured to execute the instructions to:
accept, for each change point, the designation of a hard constraint indicating a condition that must be satisfied, or a soft constraint indicating a condition that increases a penalty according to degree of unsatisfactory, as the designation of the change condition;
generate the constraint according to the hard constraint or soft constraint; and
output the change proposal of the diagram.

2. The diagram modification device according to claim 1, wherein the processor is configured to execute the instructions to:
generate the constraint in which the hard constraint is an optimization condition and the soft constraint is component of the objective function; and
generate a change proposal for the diagram by optimizing the objective function including the soft constraint under the optimization condition.

3. The diagram modification device according to claim 1, wherein the processor is configured to execute the instructions to
represent the soft constraint by a penalty function that specifies the penalty to be generated depending on degree to which the constraint is not satisfied.

4. The diagram modification device according to claim 1, wherein the processor is configured to execute the instructions to:
accept the designation of the change point and the change condition for the change proposal to the diagram;
generate the constraint for the objective function based on the designation; and
generate further change proposal for the diagram by optimizing the objective function based on the generated constraint.

5. The diagram modification device according to claim 4, wherein the processor is configured to execute the instructions to:
accept the designation of a fixed point that is not to be changed for the change proposal in the diagram; and
generate the constraint for the objective function based on the designation.

6. A diagram modification method comprising:
outputting a diagram to a display device;
accepting designation of a change point and a change condition for the displayed diagram;
when accepting the designation, for each change point, accepting the designation of a hard constraint indicating a condition that must be satisfied, or a soft constraint indicating a condition that increases a penalty according to degree of unsatisfactory, as the designation of the change condition;
generating a constraint for an objective function used for optimization of the diagram according to the hard constraint or the soft constraint, based on the designation;
generating a change proposal for the diagram by optimizing the objective function based on the generated constraint; and
outputting the change proposal of the diagram.

7. The diagram modification method according to claim 6, wherein
the constraint in which the hard constraint is an optimization condition and the soft constraint is component of the objective function is generated, and
a change proposal for the diagram is generated by optimizing the objective function including the soft constraint under the optimization condition.

8. A non-transitory computer readable information recording medium storing a diagram modification program, when executed by a processor, that performs a method for:
outputting a diagram to a display device;
accepting designation of a change point and a change condition for the displayed diagram;
generating a constraint for an objective function used for optimization of the diagram based on the designation; and
generating a change proposal for the diagram by optimizing the objective function based on the generated constraint,
wherein, the designation of a hard constraint indicating a condition that must be satisfied, or a soft constraint indicating a condition that increases a penalty according to degree of unsatisfactory, as the designation of the change condition is accepted for each change point,
the constraint is generated according to the hard constraint or soft constraint, and
the change proposal of the diagram is output.

9. The non-transitory computer readable information recording medium according to claim 8,
the constraint in which the hard constraint is an optimization condition and the soft constraint is component of the objective function is generated, and
a change proposal for the diagram is generated by optimizing the objective function including the soft constraint under the optimization condition.
